(19) United States
(12) Patent Application Publication
(10) Pub. No.: US 2018/0010584 A1
(43) Pub. Date: Jan. 11, 2018

(54) WIND TURBINE

(71) Applicant: Siemens Aktiengesellschaft, Munchen (DE)

(72) Inventors: Uffe Eriksen, Horsens (DK); Christian Laursen, Hedensted (DK); Thorkil Munk-Hansen, Fredericia (DK)

(21) Appl. No.: 15/641,457

(22) Filed: Jul. 5, 2017

(30) Foreign Application Priority Data
Jul. 7, 2016 (EP) 16178428

(51) Int. Cl. F03D 80/70

(52) U.S. Cl. CPC F03D 80/70; F05B 2280/6003; F05B 2280/105; F05B 2280/4006

(57) ABSTRACT

A wind turbine is provided, including a hub, a blade shaft which is connected to the hub, a rotor blade which is connected to the blade shaft, a fixed bearing arrangement which is arranged at a blade end) of the blade shaft, and a floating bearing arrangement which is arranged at a hub end of the blade shaft, wherein the bearing arrangements enable a rotational movement of the rotor blade relative to the blade shaft. One advantage of the wind turbine including the bearing arrangements is that a better distribution of the loads is achieved. Further, the serviceability is better compared to bearings with rolling elements.

### CROSS-REFERENCE TO RELATED APPLICATION

This application claims priority to European Application No. 16178428.5 having a filing date of Jul. 7, 2016, the entire contents of which is hereby incorporated by reference.

### FIELD OF TECHNOLOGY

The following relates to a wind turbine.

### BACKGROUND

Modern wind turbine rotor blades are built from fiber-reinforced plastics. A rotor blade typically comprises an airfoil having a rounded leading edge and a sharp trailing edge. The rotor blade is connected with its blade root to a hub of the wind turbine. The rotor blade is connected to the hub by means of a pitch bearing that allows a pitch movement of the rotor blade. The pitch bearing normally is a rolling element bearing. A longer rotor blade experiences more forces of the wind that interacts with the rotor blade. The forces are transferred over the pitch bearing of the rotor blade to the hub.

### SUMMARY

An aspect relates to an improved wind turbine.

Accordingly, a wind turbine, comprising a hub, a blade shaft which is connected to the hub, a rotor blade which is connected to the blade shaft, a fixed bearing arrangement which is arranged at a blade end of the blade shaft, and a floating bearing arrangement which is arranged at a hub end of the blade shaft, is provided, wherein the bearing arrangements enable a rotational movement of the rotor blade relative to the blade shaft.

The blade end of the blade shaft can be named distal end because it is positioned in a distance from the hub. The hub end can be named proximal end of the blade shaft because it is proximal to the hub. The blade end can also be named tip. The blade end can be pointed. In particular, the rotor blade is rotatably supported at the blade shaft by the fixed bearing arrangement and the floating bearing arrangement. The rotor blade preferably has a blade root which is fixed to the blade shaft. The blade shaft is preferably arranged inside the blade root. A blade arrangement of the wind turbine comprises preferably the hub, the blade shaft, the bearing arrangements and the blade. The wind turbine preferably comprises more than one rotor blade. In particular, the wind turbine comprises three or more rotor blades. Each rotor blade has its own blade shaft. The blade shaft extends between the hub end which is fixed to the hub and the pointed blade end. Both bearing arrangements are preferably plain bearings or sliding bearings. A fixed bearing is a bearing that can transfer loads both in a radial and in an axial direction. A floating bearing is a bearing that can transfer loads only in a radial but not in an axial direction.

The advantages of the wind turbine are the following. A better distribution of the loads is achieved. Less material is needed in the blade root and in the bearing arrangements. The serviceability is better compared to bearings with rolling elements. At rotor blades with 100 m length or more, several meters of deflection at the tip of the rotor blade are expected. This leads to high forces at the blade root and to a high misalignment in bearings at the blade shaft. Plain bearings are less sensitive to this misalignment.

According to an embodiment, the fixed bearing arrangement is positioned between the blade shaft and the rotor blade, and the floating bearing arrangement is also positioned between the blade shaft and the rotor blade. Preferably, the fixed bearing arrangement and the floating bearing arrangement together form a pitch bearing arrangement of the wind turbine. The rotor blade can be rotated relative to the blade shaft to adjust a pitch angle of the rotor blade.

According to a further embodiment, the fixed bearing arrangement comprises a radial bearing for transferring radial forces, and an axial bearing for transferring axial forces. The fixed bearing arrangement can comprise two axial bearings which are arranged at both sides of the radial bearing. An axial direction is preferably oriented parallel to a middle axis of the fixed bearing arrangement. A radial direction is preferably oriented perpendicular to the axial direction.

According to a further embodiment, the radial bearing comprises a first bearing shell that is connected to an adaptor wall of the rotor blade, and a second bearing shell that is connected to the blade shaft. The second bearing shell can be part of the blade shaft. The blade shaft can have a higher thickness in the area of the second bearing shell.

According to a further embodiment, the radial bearing and/or the axial bearing comprises exchangeable bearing pads. The exchangeable bearing pads secure a longer overall lifetime of the wind turbine or the blade arrangement. The serviceability is better compared to bearings with rolling elements. The bearing pads can be made of metal, for example copper, plastic, for example nylon, or composite materials.

According to a further embodiment, the radial bearing and/or the axial bearing is a plain bearing. A plain bearing has no rolling elements. A plain bearing can also be named as sliding bearing.

According to a further embodiment, the radial bearing has a diameter of more than 50 cm, preferably of more than 80 cm, and a length of more than 40 cm, preferably of more than 80 cm. The diameter and the length of the radial bearing are arbitrarily.

According to a further embodiment, the axial bearing has a length of more than 5 cm. The length can also be smaller than 5 cm.

According to a further embodiment, the floating bearing arrangement comprises a radial bearing for transferring radial forces. The radial bearing preferably is a plain bearing.

According to a further embodiment, the radial bearing comprises exchangeable bearing pads. The exchangeable bearing pads secure a longer overall lifetime of the wind turbine or the blade arrangement. The serviceability is better compared to bearings with rolling elements. The bearing pads can be made of metal, for example copper, plastic, for example nylon, or composite materials.

According to a further embodiment, the radial bearing is a plain bearing. This improves the durability of the radial bearing. Further, the maintenance of the radial bearing is simplified.

According to a further embodiment, the radial bearing has a diameter of more than 4 m, and a length of more than 10 cm, preferably of more than 25 cm. The diameter and the length of the radial bearing are arbitrarily.

According to a further embodiment, the blade shaft is hollow and/or the blade shaft is conical. The blade shaft can be casted. The blade shaft can be made of a metal, for example aluminum. “Conical” means that a cross-section of the blade shaft decreases from the hub end in direction of the blade end. Alternatively, the blade shaft can be cylindrical.

According to a further embodiment, the blade shaft is arranged at least partly inside the rotor blade. In particular, the blade shaft is arranged inside the root of the rotor blade.

According to a further embodiment, the fixed bearing arrangement and/or the floating bearing arrangement comprises copper, nylon or composite materials and/or wherein the fixed bearing arrangement and/or the floating bearing arrangement is lubricated. The bearing arrangements can have a sealing to prevent grease or oil from escaping and water from coming in. Suitable materials for the bearing pads can be copper, nylon or composite materials, preferably Ertalon® LFX, a nylon, also known as paxx or pcb based composite material. Lubrication of nylon can be done with grease, in particular with pcb based grease. Composite materials can run without grease.

“Wind turbine” presently refers to an apparatus converting the wind's kinetic energy into rotational energy, which may again be converted to electrical energy by the apparatus.

Further possible implementations or alternative solutions of embodiments of the invention also encompass combinations—that are not explicitly mentioned herein—of features described above or below with regard to the embodiments. The person skilled in the art may also add individual or isolated aspects and features to the most basic form of embodiments of the invention.

### BRIEF DESCRIPTION

Some of the embodiments will be described in detail, with reference to the following figures, wherein like designations denote like members, wherein:

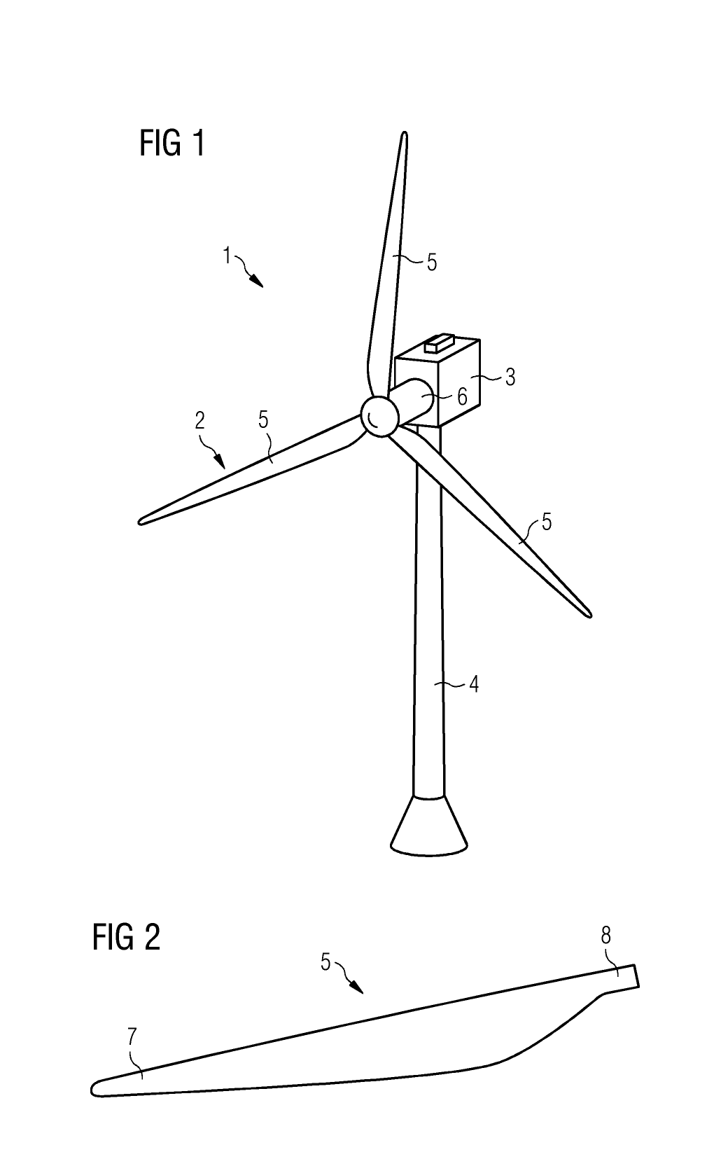

FIG. 1 is a perspective view of a wind turbine according to one embodiment;

FIG. 2 is a perspective view of a wind turbine rotor blade according to one embodiment;

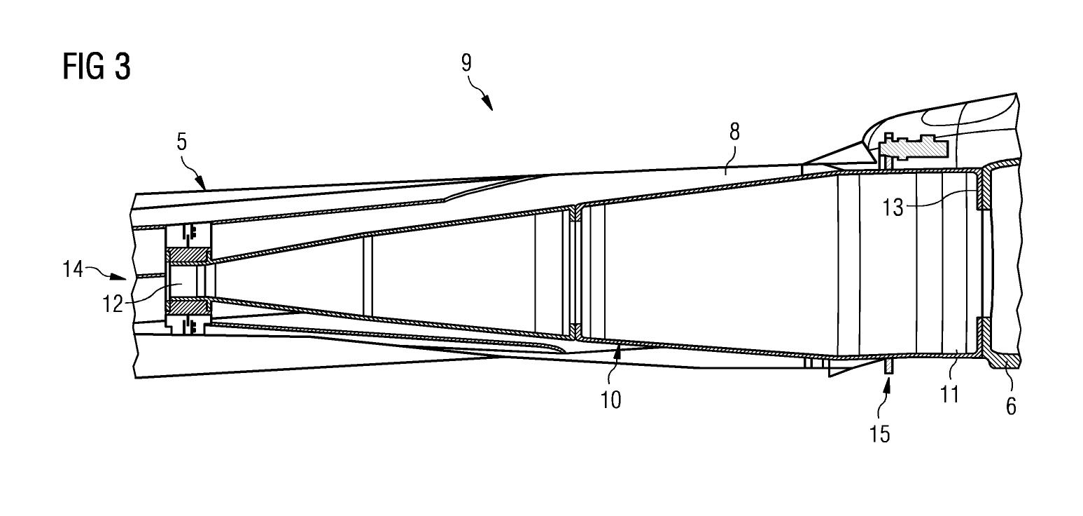

FIG. 3 is a sectional view of a blade arrangement according to one embodiment;

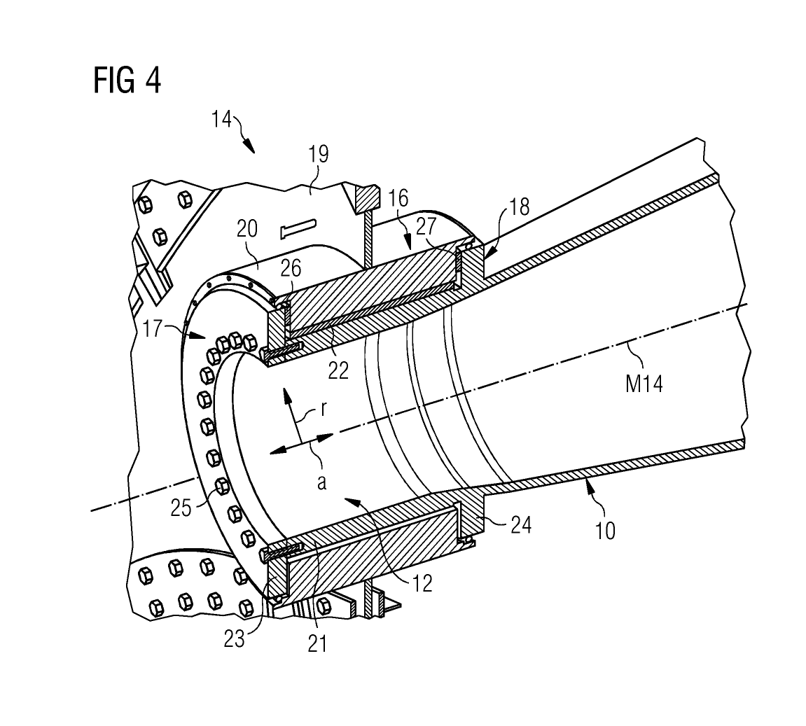

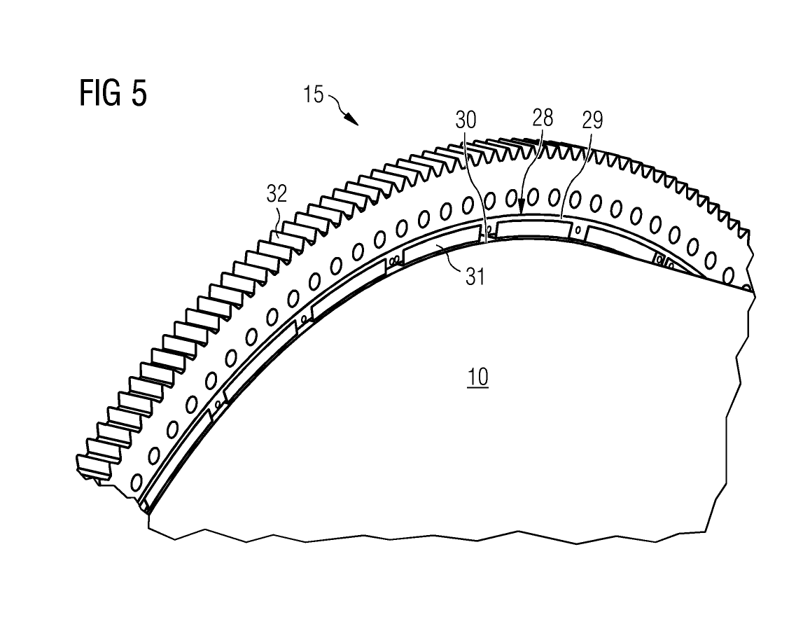

FIG. 4 is a sectional view of a fixed bearing arrangement according to one embodiment; and

FIG. 5 is a perspective view of a floating bearing arrangement according to one embodiment.

### DETAILED DESCRIPTION

FIG. 1 shows a wind turbine 1 according to an embodiment.

The wind turbine 1 comprises a rotor 2 connected to a generator (not shown) arranged inside a nacelle 3. The nacelle 3 is arranged at the upper end of a tower 4 of the wind turbine 1.

The rotor 2 comprises three rotor blades 5. The rotor blades 5 are connected to a hub 6 of the wind turbine 1. Rotors 2 of this kind may have diameters ranging from, for example, 30 to 160 meters or even more. The rotor blades 5 are subjected to high wind loads. At the same time, the rotor blades 5 need to be lightweight. For these reasons, rotor blades 5 in modern wind turbines 1 are manufactured from fiber-reinforced composite materials. Therein, glass fibers are generally preferred over carbon fibers for cost reasons. Oftentimes, glass fibers in the form of unidirectional fiber mats are used.

FIG. 2 shows a rotor blade 5 according to one embodiment.

The rotor blade 5 comprises an aerodynamically designed portion 7, which is shaped for optimum exploitation of the wind energy and a blade root 8 for connecting the rotor blade 5 to the hub 6.

FIG. 3 shows a sectional view of a blade arrangement 9 according to one embodiment.

The blade arrangement 9 comprises the hub 6, a blade shaft 10 which is fixed to the hub 6 and the rotor blade 5. The blade arrangement 9 can comprise several blade shafts 10 and several rotor blades 5. For example, the blade arrangement 9 can comprise three rotor blades 5 and three blade shafts 10, wherein each blade shaft 10 is assigned to one rotor blade 5. The blade shaft 10 is fixed to the hub such that it cannot be rotated relative to the hub 6. The blade arrangement 9 is part of the wind turbine 1. The blade shaft 10 is arranged at least partly inside the rotor blade 5.

The blade shaft 10 is conical. That means the blade shaft 10 has a broad hub end 11 which is attached to the hub 6 and a pointed tip or blade end 12 which is arranged inside the blade root 8 of the rotor blade 5. From the hub end 11 to the blade end 12 a cross sectional area of the blade shaft 10 continuously decreases. The blade shaft 10 is provided with a disc-shaped interface 13 which is arranged at the hub end 11. The interface 13 is fixed to the hub 6. For example, the interface 13 is fixed to the hub 6 by means of bolts and/or screws. The blade shaft 10 is hollow. This lowers the weight of the blade shaft 10.

The rotor blade 5 is connected to the blade shaft 10. The blade shaft 10 reaches a certain predetermined length into the rotor blade 5. The rotor blade 5 is connected at least at two areas to the blade shaft 10. One area is at the hub end 11 or the blade root 8 of the rotor blade 5 and one area is at the blade end 12 of the blade shaft 10. The connection is achieved by a fixed bearing arrangement 14 which is arranged at the blade end 12 of the blade shaft 10 and a floating bearing arrangement 15 which is arranged at the blade root 8 of the rotor blade 5 or at the hub end 11 of the blade shaft 10. The bearing arrangements 14, 15 enable a rotational movement of the rotor blade 5 relative to the blade shaft 10. Thus, a pitch angle of the rotor blade 5 can be adjusted.

The fixed bearing arrangement 14 is shown in detail in FIG. 4.

The fixed bearing arrangement 14 is positioned between the blade shaft 10 and the rotor blade 5. The fixed bearing arrangement 14 supports the rotor blade 5 at the blade end 12 of the blade shaft 10. The fixed bearing arrangement 14 comprises a radial bearing 16 and axial bearings 17, 18 to transfer radial and axial forces. The bearings 16, 17, 18 are plain bearings. That means the bearings 16, 17, 18 have no rolling elements. The radial bearing 16 can transfer loads only in a radial direction r but not in an axial direction a. The axial bearings 17, 18 can transfer loads only in the axial direction a but not in the radial direction r. The axial direction a is positioned parallel to a middle axis M14 of the fixed bearing arrangement 14. The radial direction r is positioned perpendicular to the middle axis M14 or to the axial direction a.

The rotor blade 5 comprises an adaptor wall 19 to support the fixed bearing arrangement 14. The radial bearing 16 comprises a first bearing shell 20 that is connected to the adaptor wall 19 of the rotor blade 5. The radial bearing 16 also comprises a second bearing shell 21 that is connected to the blade shaft 10 or is part of the blade shaft 10. The second bearing shell 21 can be connected to an outer surface of the blade shaft 10. The second bearing shell 21 can also be connected to the blade end 12 of the blade shaft 10. The blade shaft 10 is hollow and can be casted. The blade shaft 10 can have a higher wall thickness in the area of the radial bearing 16.

Between the first bearing shell 20 and the second bearing shell 21 is arranged a plurality of bearing pads 22. The bearing pads 22 are exchangeable. Suitable materials for the bearing pads 22 can be copper, nylon or composite materials, preferably Ertalon® LFX, a nylon, also known as paxx or pcb based composite material. Lubrication of nylon can be done with grease, in particular with pcb based grease. Composite materials can run without grease. The radial bearing 16 can have a diameter of more than 50 cm, preferably of more than 80 cm. A length of the radial bearing 16 can be more than 40 cm, preferably more than 80 cm.

Each axial bearing 17, 18 has a disc-shaped cover 23, 24. The cover 24 is part of the blade shaft 10 and the cover 23 is an extra part which is fixed to a face of the blade end 12 by means of fixing elements 25, in particular screws. Between each cover 23, 24 and the first bearing shell 20 are arranged bearing pads 26, 27. The bearing pads 26, 27 can be made of the same materials as the bearing pads 22. Each axial bearing 17, 18 can have a length of more than 5 cm.

The bearings 16, 17, 18 can have a sealing to prevent grease or oil from escaping and water from coming in. The bearings 16, 17, 18 can also be placed inside the blade shaft 10 (not shown). The fixed bearing arrangement 14 can be one unit that is exchangeable so that no exchange of the bearing pads 22, 26, 27 is necessary. This unit can be exchanged through the blade shaft 10, the hub 6 and the nacelle 3 and can be hoisted down to the ground by means of a crane. The blade shaft 10 can have an additional arrangement to secure the rotor blade 5 to the blade shaft 10 so that a rotation of the rotor blade 5 is prevented during service work and exchange of the bearing pads 22, 26, 27.

The floating bearing arrangement 15 is shown in detail in FIG. 5.

The floating bearing arrangement 15 is placed between the blade shaft 10 and the rotor blade 5. The floating bearing arrangement 15 comprises a radial bearing 28 for transferring radial forces. That means the radial bearing 28 can only transfer loads in the radial direction r but not in the axial direction a. The radial bearing 28 comprises a first bearing shell 29 and a second bearing shell 30 which can be part of the blade shaft 10.

Between the bearing shells 29, 30 is arranged a plurality of exchangeable bearing pads 31. The bearing pads 31 can be made of the same material like the bearing pads 22, 26, 27. The first bearing shell 29 is attached to the blade root 8. The first bearing shell 29 can be divided into segments to allow an easy exchange of the bearing pads 31 and/or the segments of the first bearing shell 29. The radial bearing 28 can have a diameter of more than 4 m and a length of more than 10 cm, preferably of more than 25 cm. The first bearing shell 29 can be provided with a gear ring 32 which can be used to adjust the pitch angle of the rotor blade 5.

The advantages of the wind turbine 1 comprising the blade arrangement 9 are the following. A better distribution of the loads is achieved. Less material is needed in the blade root 8 and in the bearing arrangements 14, 15. The exchangeable bearing pads 22, 26, 27, 31 secure a longer overall lifetime of the wind turbine 1 or the blade arrangement 9. The serviceability is better compared to bearings with rolling elements. At rotor blades 5 with 100 m length several meters of deflection at the tip of the rotor blade 5 are expected. This leads to high forces at the blade root 8 and to a high misalignment in bearings at the blade shaft 10. Plain bearings like the bearings 16, 17, 18, 28 are less sensitive to this misalignment.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A wind turbine, comprising a hub, a blade shaft which is connected to the hub, a rotor blade which is connected to the blade shaft, a fixed bearing arrangement which is arranged at a blade end of the blade shaft, and a floating bearing arrangement which is arranged at a hub end of the blade shaft, wherein the fixed bearing arrangement and the floating bearing arrangement enable a rotational movement of the rotor blade relative to the blade shaft.

2. The wind turbine according to claim 1, wherein the fixed bearing arrangement is positioned between the blade shaft and the rotor blade, and the floating bearing arrangement is also positioned between the blade shaft and the rotor blade.

3. The wind turbine according to claim 1, wherein the fixed bearing arrangement comprises a radial bearing for transferring radial forces, and an axial bearing for transferring axial forces.

4. The wind turbine according to claim 3, wherein the radial bearing comprises a first bearing shell that is connected to an adaptor wall of the rotor blade, and a second bearing shell that is connected to the blade shaft.

5. The wind turbine according to claim 3, wherein the radial bearing and/or the axial bearing comprises exchangeable bearing pads.

6. The wind turbine according to claim 3, wherein the radial bearing and/or the axial bearing is a plain bearing.

7. The wind turbine according to claim 3, wherein the radial bearing has a diameter of more than 50 cm, and a length of more than 40 cm.

8. The wind turbine according to claim 3, wherein the axial bearing has a length of more than 5 cm.

9. The wind turbine according to claim 1, wherein the floating bearing arrangement comprises a radial bearing for transferring radial forces.

10. The wind turbine according to claim 9, wherein the radial bearing comprises exchangeable bearing pads.

11. The wind turbine according to claim 9, wherein the radial bearing is a plain bearing.

12. The wind turbine according to claim 9, wherein the radial bearing has a diameter of more than 4 m, and a length of more than 10 cm.

13. The wind turbine according to claim 1, wherein the blade shaft is hollow and/or wherein the blade shaft is conical.

14. The wind turbine according to claim 1, wherein the blade shaft is arranged at least partly inside the rotor blade.

15. The wind turbine according to claim 1, wherein the fixed bearing arrangement and/or the floating bearing arrangement comprises copper, nylon or composite materials and/or wherein the fixed bearing arrangement and/or the floating bearing arrangement is lubricated.
